(19) United States
(12) Patent Application Publication
(10) Pub. No.: US 2026/0107923 A1
(43) Pub. Date: Apr. 23, 2026

(54) PET TOY

(71) Applicant: Doskocil Manufacturing Company, Inc., Arlington, TX (US)

(72) Inventors: Jill Jackson, Arlington, TX (US); Jessica Juarez, Arlington, TX (US); Alexandra Hackett, Arlington, TX (US)

(73) Assignee: Doskocil Manufacturing Company, Inc., Arlington, TX (US)

(21) Appl. No.: 19/363,387

(22) Filed: Oct. 20, 2025

Related U.S. Application Data
(63) Continuation of application No. 18/899,537, filed on Sep. 27, 2024, now Pat. No. 12,446,551.

(51) Int. Cl. A01K 15/02

(52) U.S. Cl. CPC A01K 15/025

(57) ABSTRACT

A pet toy includes a rod and an outer casing. The rod includes a body extending between a proximal end and a distal end, and one or more ridges extending from the body intermediate the proximal and distal ends. The outer casing includes an opening provided therein, at least a portion of the rod slidably received within the opening. The one or more ridges are configured to contact the outer casing to create a noise as the rod slides through the opening.

### CROSS-REFERENCE TO RELATED PATENT APPLICATIONS

This application is a continuation of U.S. patent application Ser. No. 18/899,537, filed Sep. 27, 2024, which is hereby incorporated herein by reference in its entirety.

### BACKGROUND

The present disclosure generally relates to a pet toy. More specifically, the present disclosure relates to a pet toy designed for interactive engagement with a pet.

A pet toy can be elongated so to have a user handle at one end and a toy object attached to a cord, such as a string or chain, at another end. These types of pet toys are particularly suitable as cat toys. Moving the pet toy causes the toy object to move in a manner that will entice a cat to chase and catch the toy object. Pet toys can be retractable for easy storage and for convenient detachment of the toy object from the cord.

### SUMMARY OF THE INVENTION

In view of the state of the known technology, one aspect of the present disclosure is to provide a pet toy comprising a rod, a fastener and an outer casing. The rod includes a plurality of ridges along a longitudinal length of the rod between a first longitudinal end and a second longitudinal end of the rod. The fastener is disposed at the first longitudinal end of the rod for detachably attaching an interactive toy to the rod. The outer casing has an opening that receives the rod therethrough. The outer casing is slidable between the first and second longitudinal ends of the rod to create a noise as the ridges ratchet against the opening of the outer casing.

In some embodiments, a pet toy comprises a rod and an outer casing. The rod includes a body extending between a proximal end and a distal end, and one or more ridges extending from the body intermediate the proximal and distal ends. The outer casing includes an opening provided therein, at least a portion of the rod slidably received within the opening. The ridges are configured to contact the outer casing to create a noise as the rod slides through the opening.

In another embodiment, a pet toy comprises a rod and an outer casing. The rod includes a body extending between a proximal end and a distal end, and a plurality of protrusions extending radially from the body intermediate the proximal and distal ends. The outer casing includes an opening, where at least a portion of the rod is slidably received within the opening. At least one projection of the plurality of projections is configured to contact the outer casing and preferably the interaction between the plurality of projections as it moves past the outer casing creates a noise as the rod slides through the opening. At least a portion of the outer casing is configured to plasticly deflect as the plurality of protrusions passes through the opening, at least a portion of the plastic deflection adapted to generate a noise

In yet another embodiment, a method of forming a pet toy includes forming a rod including a body extending between a proximal end and a distal end, and one or more ridges extending from the body. The method further includes inserting the rod within an outer casing, the outer casing including an opening, at least a portion of the rod slidably received within the opening, where the ridges are configured to contact the outer casing to create a noise as the rod slides through the opening.

### BRIEF DESCRIPTION OF THE DRAWINGS

Referring now to the attached drawings which form a part of this original disclosure:

FIG. 1 is an exploded view of a pet toy in accordance with an illustrated embodiment;

FIG. 2 is a top perspective view of the pet toy of FIG. 1 in an extended position;

FIG. 3 is a bottom perspective view of pet toy of FIGS. 1 and 2 in a retracted position;

FIG. 4 is a cross-sectional view of the pet toy in the extended position; and

FIG. 5 is a cross-sectional view of the pet toy in the retracted position.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

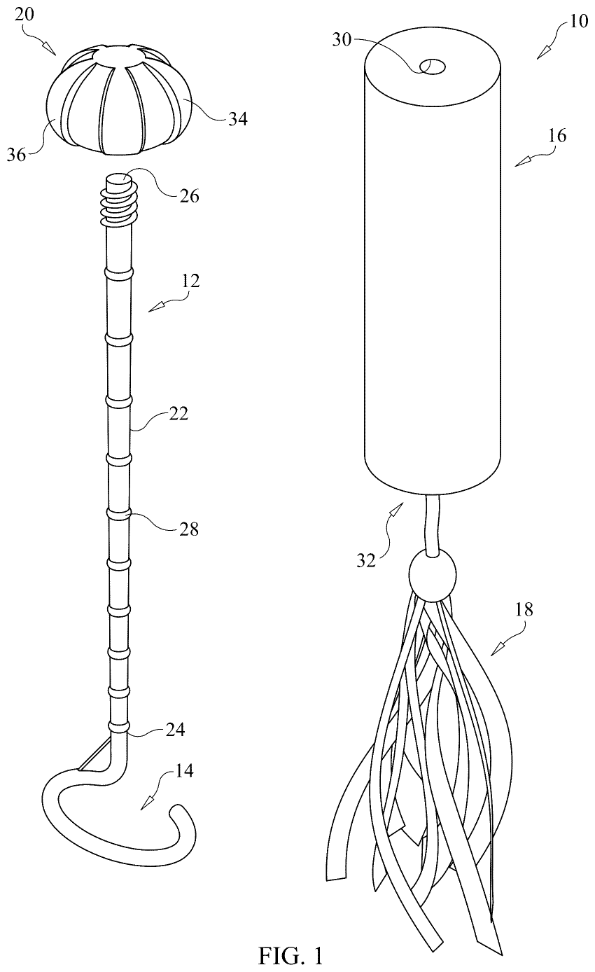

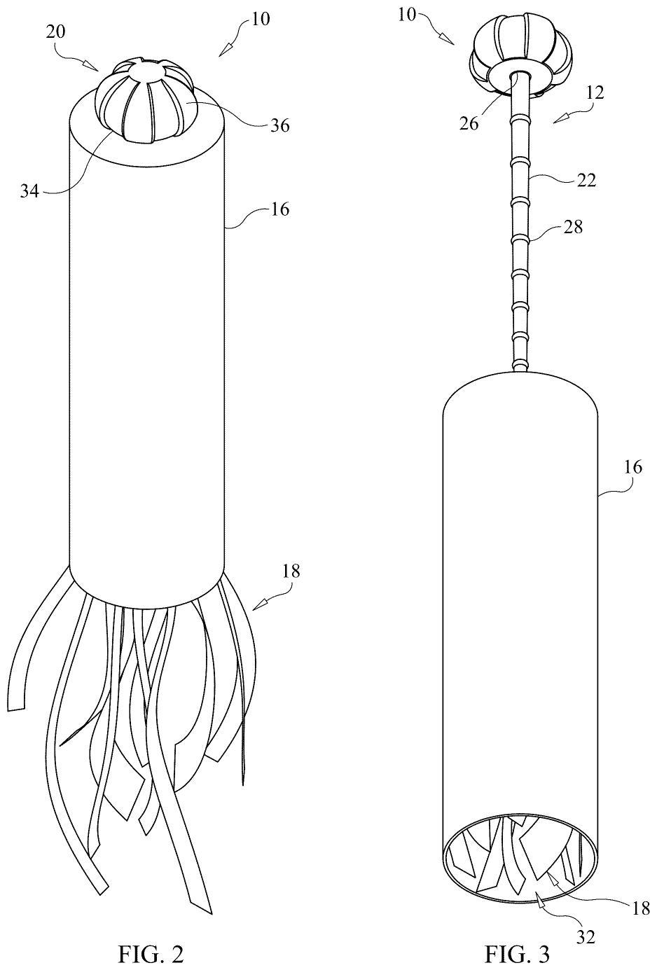

Referring initially to FIG. 1, a pet toy 10 is illustrated in accordance with an embodiment. The pet toy 10 comprises a rod 12, a fastener 14 and an outer casing 16. The pet toy 10 of the illustrated embodiment is considered a toy wand for engaging pets during play, such as a cat wand for engaging cats. Therefore, the pet toy 10 further comprises an interactive toy 18 provided at the fastener 14 for engaging a pet. The outer casing 16 slides along the rod 12 to retract and extend the interactive toy 18 from the outer casing 16 during play to sustain a pet's interest, as seen in FIGS. 2 and 3. The pet toy 10 further comprises a handle 20 provided at the rod 12 for user engagement.

The rod 12 includes an elongated main body 22 extending between a first longitudinal end 24, a proximal end and a second longitudinal end 26, a distal end of the rod 12. The fastener 14 is disposed at the first longitudinal end 24 of the rod 12, and the handle 20 is disposed at the second longitudinal end 26 of the rod 12. The rod 12 is a thin, elongated member that is preferably made of plastic. The rod 12 is preferably made to be deformable or elastic in some way such that the rod 12 retains its original form after being bent or manipulated. Therefore, the rod 12 can alternatively be made of rubber or a mix of rubber and plastic such that the rod 12 is deformable during use.

As best seen in FIG. 1, the rod 12 includes a plurality of ridges 28 disposed on the main body 22. Therefore, the ridges 28 are disposed along a longitudinal length of the rod 12. The ridges 28 are defined by a series of abutments extending radially outward from the main body 22 in intervals along the longitudinal length. The rod 12 is deformable as the outer casing 16 slides along the longitudinal length of the rod 12. The casing is operated to slide along the rod 12 to cause the ridges 28 to ratchet along the outer casing 16.

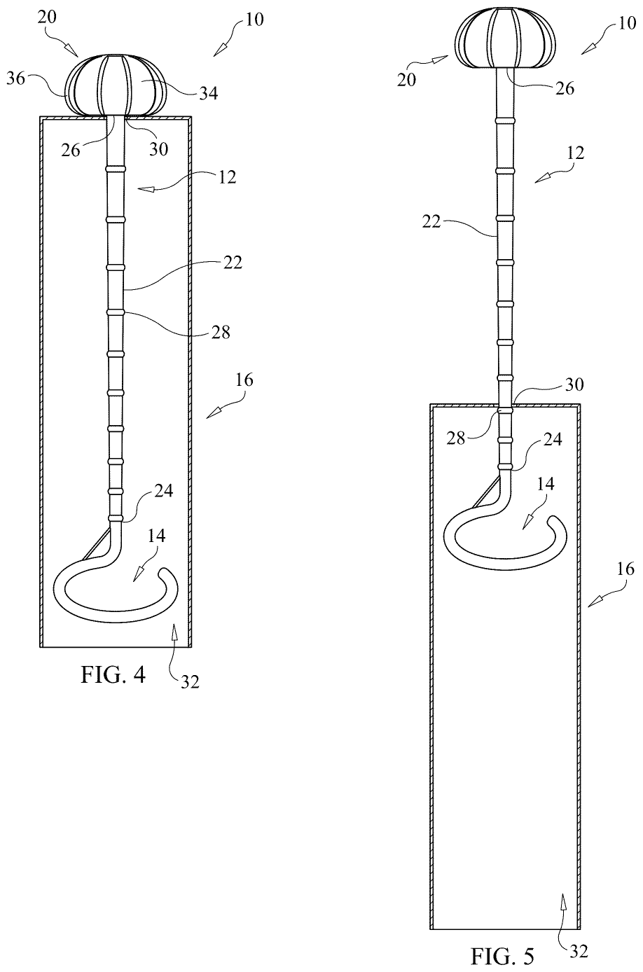

As shown in FIGS. 1, 4 and 5, the outer casing 16 has an opening 30 that receives the rod 12 therethrough. The opening 30 of the outer casing 16 has a maximum diameter that is smaller than a maximum diameter of the ridges 28 along the rod 12. The outer casing 16 is slidable between the first and second longitudinal ends 24 and 26 of the rod 12 to create a noise as the ridges 28 ratchet against the opening 30 of the outer casing 16. The outer casing 16 and the rod 12 preferably interact to create a crisp crackling or snap-like sound caused by the outer casing 16 sliding against the ridges 28. The sound is designed to engage a pet's interest.

The outer casing 16 includes a hollow interior 32 that receives the interactive toy 18 when the interactive toy 18 is retracted into the outer casing 16, as seen in FIGS. 3 to 5. The outer casing 16 is rigid and non-deformable. The outer casing 16 is preferably made of a thicker plastic than the rod 12. Alternatively, the outer casing 16 can be made of cardboard that is fortified with an outer plastic shell. While the outer casing 16 is illustrated as a cylinder in the illustrated embodiment, it will be apparent to those skilled in the pet products field from this disclosure that the outer casing 16 can be provided to have other types of shapes, such as a cone, a dome or a series of domes, etc.

The fastener 14 is disposed at the first longitudinal end 24 of the rod 12 for detachably attaching the interactive toy 18 to the rod 12. That is, the interactive toy 18 is fastened to the rod 12 via the fastener 14. As shown, the fastener 14 is an open hook for attaching the interactive toy 18 thereto. The open hook can receive a loop of the interactive toy 18. The fastener 14 can also be a snap hook that can open and close to receive and release the hook as necessary. That is, the fastener 14 is a hook and the interactive toy 18 is attached to the hook. The hook can also be releasably attached to the rod 12, such as being capped to the first longitudinal end 24 by interference fit. This way, the interactive toy 18 can be released from the rod 12 upon enough force from the pet.

The interactive toy 18 is provided to the rod 12 by the fastener 14. The interactive toy 18 extends from the outer casing 16 as the outer casing 16 slides towards the second longitudinal end 26, as seen in FIG. 2. As shown in FIG. 3, the interactive toy 18 retracts into the outer casing 16 as the outer casing 16 slides towards the first longitudinal end 24. That is, the interactive toy 18 is extended or revealed from the outer casing 16 when the outer casing 16 slides upward towards the handle 20. The interactive toy 18 is then encased by the outer casing 16 as the outer casing 16 slides down the rod 12 from the handle 20 towards the interactive toy 18.

While the interactive toy 18 is illustrated as ribbons, it will be apparent to those skilled in the vehicle field that the interactive toy 18 can be any other types of toys as desired. For example, the interactive toy 18 can be provided as one or more butterflies, one or more fish, etc. The interactive toy 18 is made of fabric or a mixture of fabric and other textured materials such as feathers. Therefore, the interactive toy 18 can include plastic streamers or spongelike extensions for providing different types of textures for the pet's engagement.

The handle 20 is detachably provided to the second longitudinal end 26 of the rod 12. Preferably, the handle 20 includes internal threads that engages with threads of the first longitudinal end 24 of the rod 12. That is, the handle 20 is threadedly engaged with the rod 12. However, it will be apparent to those skilled in the pet products field from this disclosure that the handle 20 can be provided to the rod 12 as a cap by snap-fit or by interference fit. The handle 20 is provided as a circular object with a textured surface having ridges and indentations to facilitate user engagement. The handle 20 includes a user engagement surface for securing and removing the handle 20. The handle 20 is sized and dimensioned for easy fit into a user's palm and for easy gripping at the ridges and/or indentations along the user engagement surface 34 in order to operate the handle 20 such as by rotating to thread or unthread the handle 20 with respect to the rod 12. When the handle 20 is removed from the rod 12, the outer casing 16 can be also removed from the handle 20. Thus, the outer casing 16 is removable from the rod 12 when the handle 20 is removed from the rod 12 so that the pet can enjoy a playing with the rod 12 and the interactive toy 18 without the outer casing 16.

In the illustrated embodiment, the handle 20 is provided as a circular member with radially extending ridges provided in a circumferential direction on the handle 20. Therefore, the handle 20 includes an outer circumferential surface 36 that defines an outer perimeter of the handle 20. However, it will be apparent to those skilled in the pet products field from this disclosure that the handle 20 can come in different types of shapes and/or sizes as needed or desired, such as a cube or a star.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pet toy comprising:
a rod including:
a body extending between a proximal end and a distal end, and
one or more ridges extending from the body intermediate the proximal and distal ends; and
an outer casing including an opening provided therein, at least a portion of the rod slidably received within the opening;
wherein the one or more ridges are configured to contact the outer casing to create a noise as the rod slides through the opening.

2. The pet toy of claim 1, further comprising a fastener located at the distal end of the rod, the fastener configured to couple an interactive element to the rod.

3. The pet toy according to claim 2, wherein the outer casing includes a hollow interior that is structured to receive the interactive element.

4. The pet toy according to claim 3, further comprising the interactive element coupled to the fastener,
wherein the interactive element is at least partially retracted into the outer casing when the distal end of the rod is proximate the opening,
wherein the interactive element is at least partially protruding from the outer casing when the proximal end of the rod is proximate the opening.

5. The pet toy according to claim 1, further comprising a handle coupled to the proximal end of the rod.

6. The pet toy according to claim 5, wherein the handle includes an outer circumferential surface that defines an outer perimeter of the handle.

7. The pet toy according to claim 5, wherein:
the handle includes internal threads; and
the proximal end of the rod includes external threads, the internal threads configured to engage with the external threads to couple the handle to the rod.

8. The pet toy according to claim 1, wherein at least one of the rod and the outer casing includes a deformable material such that the at least one of the rod and the outer casing deforms as the one or more ridges contact the outer casing.

9. The pet toy according to claim 8, wherein the outer casing is rigid and non-deformable.

10. The pet toy according to claim 1, wherein each of the one or more ridges extends radially toward the outer casing.

11. The pet toy according to claim 1, wherein the opening of the outer casing has a maximum diameter smaller than a maximum diameter of each of the one or more ridges.

12. The pet toy according to claim 11, further comprising a handle coupled to the proximal end of the rod.

13. The pet toy according to claim 12, wherein the outer casing is separable from the rod when the handle is removed from the rod.

14. The pet toy according to claim 12, further comprising a fastener located at the distal end of the rod, the fastener configured to couple an interactive element to the rod, wherein the fastener is a hook.

15. The pet toy according to claim 12, wherein the handle includes an outer circumferential surface that defines an outer perimeter of the handle.

16. The pet toy according to claim 12, wherein:
the handle includes internal threads; and
the proximal end of the rod includes external threads, the internal threads configured to engage with the external threads to couple the handle to the rod.

17. A pet toy comprising:
a rod including:
a body extending between a proximal end and a distal end, and
a plurality of protrusions extending radially from the body intermediate the proximal and distal ends; and
an outer casing including an opening, at least a portion of the rod slidably received within the opening;
wherein at least a portion of the outer casing is configured to plasticly deflect as the plurality of protrusions passes through the opening, at least a portion of the plastic deflection adapted to generate a noise.

18. A method of forming a pet toy, the method including:
forming a rod comprising:
a body extending between a proximal end and a distal end, and
one or more ridges extending from the body intermediate the proximal and distal ends; and
inserting the rod within an outer casing, the outer casing including an opening provided therein, at least a portion of the rod slidably received within the opening;
wherein the one or more ridges are configured to contact the outer casing to create a noise as the rod slides through the opening.

19. The method of claim 18, further comprising coupling an interactive toy to a fastener located at the distal end of the rod, wherein the interactive toy retracts into the outer casing as the outer casing slides towards the distal end, the interactive toy extends from the outer casing as the outer casing slides towards the proximal end.

20. The method of claim 18, wherein the opening of the outer casing has a maximum diameter smaller than a maximum diameter of each of the one or more ridges.
